(19) United States
(12) Patent Application Publication
(10) Pub. No.: US 2011/0021102 A1
(43) Pub. Date: Jan. 27, 2011

(54) Hot Melt Adhesive

(76) Inventors: Kentarou Inoue, Osaka (JP); Keiko Ide, Osaka (JP)

Correspondence Address: Henkel Corporation, 10 Finderne Avenue, Suite B, Bridgewater, NJ, 08807, US

(21) Appl. No.: 12/894,849

(22) Filed: Sep. 30, 2010

Related U.S. Application Data
(63) Continuation of application No. PCT/US2009/038971, filed on Mar. 31, 2009.

(51) Int. Cl. D04H 13/00; C08L 53/02

(52) U.S. Cl. 442/327; 525/98

(57) ABSTRACT

A hot melt adhesive is provided that has low viscosity, a high softening point, superior heat resistance, and a high degree of adhesive strength and adhesion stability at high temperatures. The adhesives of the invention comprise (A) an amorphous alpha olefin, (B) a crystalline poly-alpha olefin and (C) hydrogenated thermoplastic block copolymer which are copolymers with vinyl aromatic hydrocarbons and conjugated diene compounds. The adhesive is particularly useful in the manufacture of articles including laminations.

### CROSS-REFERENCE TO RELATED APPLICATIONS

This application is a continuation of International Application No. PCT/US2009/038971 filed Mar. 31, 2009, which claims priority to Japanese Application No. 2008-089848 filed Mar. 31, 2008, both of which are incorporated herein by reference.

### FIELD OF THE INVENTION

The present invention relates to hot melt adhesive and to laminates having adherends bonded together with this hot melt adhesive.

### BACKGROUND OF THE INVENTION

Hot melt adhesives are used in a wide variety of fields, including, for example, paper manufacturing, sanitary materials, and in the construction field. Hot melt adhesives are used in the construction field in the manufacture of laminates that are incorporated into roofs. “Laminates” are formed by bonding together adherends such as nonwoven fabrics as base materials to synthetic resin sheeting, and the like. These products are used, for example, as vapor-permeable sheeting, waterproofing sheeting, and the like. Vapor-permeable sheeting and waterproofing sheeting are incorporated into roofs and reach extremely high temperatures when heated by the outside air. Therefore, the hot melt adhesives used in the construction industry must have superior heat resistance.

Published Unexamined Japanese Patent Application 2003-292918 discloses a hot melt adhesive for wrapping applications wherein a synthetic resin sheeting is bonded to curved surfaces or to uneven materials with irregular cross-sections (profile). In the embodiment described in JP 2003-292918, the hot melt adhesive is compounded with synthetic rubber, unhydrated tackifiers, and acid-modified polyolefin to increase its heat resistance and adhesive strength. By using a specific composition, it can be used as a bonding adhesive in wrapping applications such as, for example, in bonding the of PET sheeting or other synthetic resin sheeting to the curved surfaces of MDF or other wood-based materials, even if they have curved surfaces.

While the hot melt adhesive of JP 2003-292918 is appropriate for bonding PET sheeting to the aforementioned wood-based materials, it is not suitable for bonding PET sheeting to textile products. This is believed to be because of the high viscosity of the hot melt adhesive of JP 2003-292918. Since it is difficult for adhesives having high viscosity to impregnate textile products, a hot melt adhesive having reduced viscosity is necessary to bond textile products to synthetic resin sheeting.

The blending of amorphous poly-alpha olefin is known as a means to reduce the viscosity of hot melt adhesives. By blending amorphous poly-alpha olefin, not only is viscosity reduced, but the softening point is also raised, so the heat resistance of the hot melt adhesive is improved. The hot melt adhesive of JP 2003-292918 contains a large amount of amorphous poly-alpha olefin (APAO). Nevertheless, since amorphous poly-alpha olefin has low cohesion, the adhesive strength of the hot melt adhesive is reduced and its performance as an overall hot melt adhesive is inadequate.

Published Unexamined Japanese Patent Application 2006-241444 discloses a rubber-based hot melt adhesive which is used to bond nonwoven fabric. The hot melt adhesive of JP 2006-241444 was developed to enhance adhesive strength within the range of 0-60° C. The composition of the JP 2006-241444 hot melt adhesive comprises tackifiers having 2 different softening points, and by adjusting the blending ratio of styrene block copolymers to tackifiers, a hot melt adhesive which can be used within the broad temperature range of 0-60° C. is obtained. Nevertheless, the adhesives used in construction material applications in recent years required still higher levels of heat resistance (heat resistance in temperature ranges above 60° C.), and the heat resistance of the hot melt adhesive disclosed in JP 2006-241444 is therefore not sufficient.

Published Unexamined Japanese Patent Application 2000-282006 discloses a rubber-based hot melt adhesive for nonwoven fabrics. Typically, styrene block copolymers (such as SEPS and SEBS) do not have good ability to penetrate into non-woven fabrics due to their high viscosity. Due to its high plasticizing oil content, the hot melt adhesive disclosed in JP 2000-282006 has reduced viscosity and enhanced ability to penetrate into nonwoven fabrics. However, due to the large quantity of plasticizers contained the hot melt adhesive of JP 2000-282006, the hot melt adhesive has a softening point of 84-107° C. Therefore, its heat resistance is insufficient.

When vapor-permeable sheeting is prepared by bonding nonwoven fabric to synthetic resin sheeting using hot melt adhesive having inferior heat resistance, long-term exposure of such vapor-permeable sheeting to the outside air creates the risk of delamination of the nonwoven fabric from the synthetic resin sheeting. Therefore, the construction industry needs a hot melt adhesive with a high degree of adhesive strength and adhesion stability at high temperatures.

### SUMMARY OF THE INVENTION

It is therefore an objective of the present invention to resolve the aforesaid problems and to provide a hot melt adhesive having low viscosity, a high softening point, superior heat resistance, and a high degree of adhesive strength and adhesion stability at high temperatures, which is to say a hot melt adhesive which can withstand the requirements of the building materials industry. It is moreover an objective of this invention to provide a laminate obtained by using this hot melt adhesive.

As a result of intensive research by the inventors, the inventors have devised a hot melt adhesive having a superior ability to penetrate textile products with low viscosity and moreover with superior bonding due to its high softening point, heat resistance, bond strength, and adhesion stability at high temperatures by blending crystalline poly-alpha olefin having a narrow distribution of molecular weight into an amorphous poly-alpha olefin.

Thus, in the one embodiment of this invention, a hot melt adhesive is provided which includes:
(A) an amorphous alpha olefin,
(B) a crystalline poly-alpha olefin obtained by polymerization of an alpha olefin in the presence of a metallocene catalyst, and
(C) a hydrogenated thermoplastic block copolymer which are copolymers with vinyl aromatic hydrocarbons and conjugated diene compounds (hereinafter, “(C) hydrogenated thermoplastic block copolymer).

In another embodiment of the present invention, a hot melt adhesive is provided in which the (C) hydrogenated thermoplastic block copolymer of the hot melt adhesive is a hydrogenated composition of styrene-isoprene-styrene block copolymer (SEPS).

In another embodiment of this invention, a hot melt adhesive is provided in which (A) amorphous poly-alpha olefin, (B) crystalline poly-alpha olefin, and (C) hydrogenated thermoplastic block copolymers (100 weight parts) are blended in a ratio 10-40 weight parts of (B).

In yet another embodiment, the invention provides a laminate obtained by using the aforementioned hot melt adhesive.

### DETAILED DESCRIPTION OF THE INVENTION

In this Specification, “laminate” refers to what is typically known as a lamination, and more specifically to a structure in which adherends such as synthetic resin sheeting, synthetic resin film, and the like are bonded to a variety of base materials.

While there is no limitation on the synthetic resins which may serve as raw materials for the sheeting or film which are the adherends, these may be polyolefins, polyethylenes terephthalates, polyurethanes, or the like. Such examples of polyolefins, as polyethylene, polypropylene, ethylene/propylene copolymers, and polybutene can be mentioned.

Base materials such as, for example, fabrics woven of synthetic fibers (for example polyolefin, polyester, nylon, or acrylate), natural fibers (silk, cotton, flax, wool, or the like), inorganic fibers (glass fibers, mineral fibers, or the like), or non-woven fabric, or knits thereof, as well as rubber, paper, metals, wood, glass, concrete mortar, or the like can be mentioned.

The hot melt adhesive of this invention has low viscosity with superior heat resistance because it includes (A) amorphous poly-alpha olefin and (B) crystalline poly-alpha olefin obtained by polymerized in alpha olefin with metallocene catalyst, and moreover, it has high adhesive strength due to the inclusion of hydrogenated thermoplastic block copolymers which are copolymers of (C) vinyl aromatic hydrocarbons and conjugated diene compounds. Therefore, the aforementioned hot melt adhesive is an adhesive suitable for building material applications, facilitating a strong bond of synthetic resin sheeting (film), and other such adherends to nonwoven and the like base materials.

An adhesive having still stronger adhesive strength can be obtained when the (C) hydrogenated thermoplastic block copolymers of the hot melt adhesive of the present invention has a hydrogenation composition of styrene-isoprene-styrene block copolymer (SEPS).

The hot melt adhesive of this invention will maintain low viscosity when (A) amorphous poly-alpha olefin, (B) crystalline poly-alpha olefin, and (C) hydrogenated thermoplastic block copolymers (100 weight parts) are blended in a ratio 10-40 weight parts of (B), and is superior due to heat resistance and adhesion stability, and it still more suitable as an adhesive for building material applications.

The lamination obtained using this hot melt adhesive is used in the construction industry, creating a layered structure that is unlikely to delaminate even when exposed to high temperatures over long periods of time, and more specifically, making it unlikely that adherends such as base materials such as nonwoven fabrics and the like and synthetic resin sheeting (or films) and the like would delaminate.

The hot melt adhesive of this invention contains (A) amorphous poly-alpha olefin, (B) crystalline poly-alpha olefin, and (C) hydrogenated thermoplastic block copolymers.

In this invention, the “(A) amorphous poly-alpha olefin (hereinafter, Component (A)”) is a polymer of amorphous alpha olefin which is typically called amorphous poly-alpha olefin, and to the extent that the hot melt adhesive of the present invention can be obtained, there is no particular limitation thereon. “Amorphous” typically means that which is not crystalline, but more specifically in this case, amorphous refers to an irregular array of molecular chains having high molecular weight. By blending (A) amorphous poly-alpha olefin into a hot melt adhesive, the hot melt adhesive has reduced viscosity and more easily penetrates into nonwoven fabrics and other base materials.

(A) amorphous poly-alpha olefin may, for example, be amorphous polypropylene, amorphous polyethylene, or a copolymer of amorphous polypropylene and another alpha-olefin, as well as a copolymer of amorphous ethylene and another alpha-olefin.

More specifically, (A) amorphous poly-alpha olefin may be propylene-ethylene copolymer, propylene.butene 1 copolymer, propylene.butene-1-ethylene tertiary copolymer, propylene.hexene-1.4-methylpentene-1 tertiary copolymer, or polybutene-1, or the like.

In this invention, the “(B) crystalline poly-alpha olefin obtained by polymerized in alpha olefin with metallocene catalyst (hereinafter “(B) crystalline poly-alpha olefin” or “Component (B)”), indicates a crystalline copolymer of alpha-olefin, and is manufactured using metallocene catalyst as the polymerization catalyst. Here, “crystalline” typically refers to that which is “crystalline,” and more specifically it means that the macromolecules are regularly arrayed.

(B) crystalline poly-alpha olefin may, for example, be polyethylene, polypropylene, ethylene propylene copolymer, ethylene alpha-olefin copolymer, propylene alpha olefin copolymer, ethylene propylene alpha olefin copolymer, ethylene butene copolymer, propylene butene copolymer, or ethylene propylene butene copolymer.

When alpha-olefin is polymerized using metallocene catalyst, a polymer is synthesized which (i) is highly crystalline and (ii) has an extremely narrow distribution of molecular weight. (i) means that isotacticity and syndiotacticity can be fully controlled at will. Therefore, a uniform polymer having no deviations in crystallinity is formed which is uniform in terms of its molecular composition, such as the arrangement of the propylene and other constituent units; uniform in the ratio of content of the other constituent units, and the like, reducing the possibility of low-crystalline locations which are the cause of decreased adhesive strength. (ii) means that the formation of low-molecular weight parts having poor adhesive strength is prevented, and that it is unlikely that there would be a decrease in adhesive strength or generation of tack.

In this invention, “(C) hydrogenated thermoplastic block copolymer which are copolymers with vinyl aromatic hydrocarbons and conjugated diene compounds (hereinafter “hydrogenated thermoplastic block copolymer” or “Component (C)”), a block copolymer of vinyl aromatic hydrocarbon and conjugated diene compounds, and it means that all or part of the block based upon the conjugated diene compound contained in the block copolymer thus obtained is hydrogenated block copolymer. There are no particular limitations on (C) hydrogenated thermoplastic block copolymer, as long as the hot melt adhesive which is the objective of this invention can be obtained.

The “vinyl aromatic hydrocarbon” means and aromatic hydrocarbon compound having a vinyl group and, more specifically, may be styrene, o-methylstyrene, p-methylstyrene, p-tert-methylstyrene, 1,3-dimethylstyrene, α-methylstyrene, vinylnaphthalene, vinylanthracene, or the like. Styrene is particularly preferable. These vinyl aromatic hydrocarbons may be used singly or in combination thereof.

The “conjugated diene compound” means at least one pair of diolefins having a conjugated double bond. Specifically, “conjugated diene compound” may, for example, be 1,3-butadiene; 2-methyl-1,3-butadiene (or isoprene); 2,3-dimethyl-1,3-butadiene; 2,3 dimethyl-1 3 butadiene; 1,3-pentadiene; 2-methyl-1,3 butadiene are most preferable. These conjugated diene compounds may be used singly or in combination thereof.

The hydrogenated ratio in (C) hydrogenated thermoplastic block copolymer indicates the “hydrogenation rate.” The “hydrogenation rate” of the (C) hydrogenated thermoplastic block copolymer means the total aliphatic bonds contained in the block based upon the conjugated diene compound as a standard, and of these, the proportion of double bonds that are hydrogenated and converted to saturated hydrocarbons. The “hydrogenation rate” can be measured using an infrared spectrophotometer, a nuclear magnetic resonance device, or the like.

A preferred embodiment of this invention is one in which the (C) hydrogenated thermoplastic block copolymer contains hydrogenated styrene triblock copolymer. A particularly preferable embodiment is one in which the (C) hydrogenated thermoplastic block copolymer moreover contains hydrogenated styrene diblock copolymer.

The hydrogenated styrene triblock copolymer may specifically be, for example, SEPS triblock copolymer, SEBS triblock copolymer, SEEPS triblock copolymer, or SEEBS triblock copolymer.

SEPS triblock copolymer is comprised of a styrene polymer block terminal block and a central block which is a mixture of and ethylene structure and a propylene structure. Therefore, it is a styrene-ethylene/propylene-isoprene-styrene copolymer (styrene-isoprene-styrene (SIS) block copolymer hydrogenated composition).

SEBS triblock copolymer is a block copolymer comprised of a styrene polymer block terminal block and a central block consisting of a mixture of and ethylene structure and a butylene structure. Therefore, it is a styrene-ethylene/butylenestyrene copolymer (styrene-/butadiene-styrene (SBS) block copolymer hydrogenated composition).

SSEPS is a block copolymer of a styrene terminal block and a central block consisting of hydrogenated isoprene/butadiene.

The hydrogenated styrene diblock copolymer may specifically be, for example, SEB diblock copolymer or SEP diblock copolymer. SEB diblock copolymers are block copolymers of a styrene block and a hydrogenated butadiene block, and are styrene-ethylene-butylene copolymers. SEP diblock copolymers are block copolymers of a styrene block and a hydrogenated isoprene block, and are styrene-ethylenepropylene copolymers.

Commercial versions of SEPS are, for example, Septon 2002 and 2063 (trade names) made by Kuraray, Inc.;

Commercial versions of SEBS are, for example, Kraton G165, G1650, G1654, and G1651 (trade names) from Kraton Polymers LLC;

Commercial versions of SEEPS are, for example, Septon 4033, 4044, 4055 (trade names) from Kuraray, Inc.;

Commercial versions of SEP are, for example, G1701 and G1702 (trade names) from Kraton Polymers, Inc.

These triblock copolymers and diblock copolymers may be used singly or in combination thereof as the (C) hydrogenated thermoplastic block copolymers in the present invention, but it is particularly preferable that SEPS be included.

The weight parts of Components (A), (B), and (C) use the total weights of Components (A)-(C) as a standard, which is to say, out of 100 weight parts, it is preferable that Component (B) be blended at 10-40 weight parts, and still more preferably at 20-30 weight parts. If the proportion of Component (B) is less than 10 weight parts, the ability of the hot melt adhesive to retain its adhesive strength for long periods of time at high temperatures is reduced and if Component (B) is blended at above 40 weight parts, the cohesive power of the hot melt adhesive becomes too high and its adhesive strength decreases.

The hot melt adhesive of the present invention may as needed moreover contain a variety of additives. These additives may, for example, be tackifiers, stabilizers (antioxidants or UV light absorbers), wax, fine grain fillers, or the like.

As examples of “(D) tackifiers,” such substances as natural rosin, modified rosin, hydrogenated rosin, natural rosin and glycerol ester, modified rosin and glycerol ester, natural rosin and pentaerythritol ester, modified rosin and pentaerythritol ester, hydrogenated rosin and pentaerythritol ester, natural terpene copolymer, natural terpene tertiary polymer, hydrogenated terpene copolymer hydrogenated derivatives, polyterpene resin, phenolic modified terpene resin hydrogenated derivatives, aliphatic petroleum hydrocarbon resin, aliphatic petroleum hydrocarbon resin hydrogenated derivatives, aromatic petroleum hydrocarbon resin, aromatic petroleum hydrocarbon resin hydrogenated derivatives, cyclic aliphatic petroleum hydrocarbon resin, cyclic aliphatic petroleum hydrocarbon resin hydrogenated derivatives, among others, can be mentioned. These tackifiers may be used singly or in combination thereof.

Commercial products can be used as tackifiers. Examples of these sorts of commercial products are: YS Polystar T115 (trade name) from Yasuhara Chemical Co. Ltd.; ECR5400, ECR179EX (trade names) from Exxon Inc.; Maruca Clear-H (trade name) from Maruzen Petrochemicals Ltd.; Clearon K100 (trade name) from Yasuhara Chemical Co. Ltd.; Arkon M-100 (trade name) from Arakawa Chemical Co. Ltd.; I-MARV S100 (trade name) from Idemitsu Kosan Co.; Clearon K4090 (trade name) from Yasuhara Chemical Co. Ltd.; and Regalite R7100 from Eastman Chemical Co. These commercial tackifiers may be used singly or in combination thereof.

Liquid-type tackifiers may be used as long as the (D) tackifier is clear to pale yellow in color, substantially free of odor, and has excellent heat stability, but it is preferable in this invention that a solid-type powdered tackifier be used rather than a liquid-type tackifier. The use of solid-type powdered tackifiers such as phenolic modified terpene resin hydrogenated derivatives or petroleum hydrocarbon hydrogenated derivatives is particularly preferable. Such phenolic modified terpene resin hydrogen derivatives as YS Polystar T115 (trade name) from Yasuhara Chemical Co. Ltd. and, as petroleum hydrocarbon hydrogenated derivatives, Arkon M-100 (trade name), can be mentioned.

“Stabilizers” prevent the reduction of molecular weight due to heat of the hot melt adhesive, as well as preventing gelling, coloring, odors, and the like, are blended in to enhance the stability of the hot melt adhesive, and there is no limitation on them to the extent that the objectives of the hot melt adhesive of the present invention are met. Stabilizers such as antioxidants and UV light absorbers can be mentioned. UV light absorbers are used to improve the light fastness of the hot melt adhesive. Antioxidants are used to prevent oxidation deterioration of the hot melt adhesive. Antioxidants and UV light absorbers are typically used in disposable products and there is no particular limitation on them as long as the disposable product to be described below can be obtained.

As the “(E) antioxidant,” phenolic antioxidants, sulfuric antioxidants, and phosphoric antioxidants can be mentioned. Such UV light absorbers as benzotriazole UV light absorbers and benzophenone UV light absorbers can be mentioned. Moreover, lactone stabilizers can be added, as well. These can be used singly or in combination thereof. Such commercial products as Sumilizer GM (trade name), Sumilizer TPD, and Sumilizer TPS (trade name) from Sumitomo Chemical Industries Ltd.; Irganox 1010 (trade name), Irganox HP2225FF (trade name), Irganox 168 (trade name), Irganox (1520) (trade name), Tinuvin P from Ciba Specialty Chemicals Co. Ltd.; JF-77 (trade name) from Johoku Chemical Co. Ltd.; Tominox TT (trade name) from API Corporation can be mentioned. These stabilizers can be used singly or in combination thereof.

“Waxes” may be the waxes which are typically used in hot melt adhesives and there are no particular limitations thereupon as long as a hot melt adhesive can be obtained which meets the objectives of the present invention. Specifically, such synthetic waxes as Fischer-Tropsch wax, polyolefin wax (polyethylene wax for polypropylene wax), or the like; petroleum waxes such as paraffin wax, microcrystalline wax, or the like; or natural waxes such as castor wax, or the like can be mentioned.

Fine grain fillers, plasticizers, and the like may also be included in the hot melt adhesive of this invention. These fine grain fillers may be fillers which are typically used, and there is no particular limitation on them to the extent that a hot melt adhesive which meets the objectives of the present invention can be obtained. “Fine-grained fillers” may, for example, be mica, calcium carbonate, kaolin, talc, titanium oxide, diatomaceous earth, urea resin, styrene beads, sintered clay, starch, or the like. The preferred shape is spherical and there is no particular limitation on the dimensions (diameter in the case of spheres) thereof.

“Plasticizers” are blended in to reduce the melt viscosity of hot melt adhesive, to contribute to flexibility, and to enhance wetting of the adherents. There are no particular limitations on plasticizers as long as they are compatible with the block copolymers and make it possible to obtain the hot melt adhesive which is the objective of this invention. Plasticizers may be, for example, paraffinic oils, naphthalenic coils, or aromatic oils. Paraffinic/naphthalenic oils are preferable, and paraffinic oils, which are colorless and odorless, are most desirable.

As examples of commercial plasticizers, White Oil Broom 350 (trade name) from Kukdong Oil & Chemical Co. Ltd.; Diana Process Oil S-21 (trade name), Diana Process Oil PW-90 (trade name), and Daphne Oil (trade name) from Idemitsu Kosan Co. Ltd.; Enerper M1930 (trade name) from BP Chemicals Co. Ltd.; Kaydol (trade name) from Crompton Corporation; Primol 352 (trade name) from Exxon Inc.; Process Oil and NS-100 (trade name) from Idemitsu Kosan Co. Ltd. can be mentioned. These may be used singly or in combination thereof.

Generally-known methods for the manufacture of hot melt adhesives are used in the manufacture of the hot melt adhesive of the present invention, and can be manufactured by blending Components (A), (B), and (C) along with the various additives as needed. For example, it can be manufactured by blending and heat melting the aforementioned components in the required amounts. There are no particular limitations on the order in which components are added, the heating method, or the like, so long as the hot melt adhesive which is the objective can be obtained.

The hot melt adhesive of this invention has a viscosity of 400 mPA·s to 500 mPA·s at 160° C. The hot melt adhesive with a viscosity in this range is desirable, having a high ability to impregnate base materials such as nonwoven fabrics and the like. The viscosity spoken of in this Specification refers to the value measured with a Brookfield viscometer using a #27 rotor.

The hot melt adhesive of this invention preferably has a softening point of the above 100° C., and it is still more preferable for it to have a softening point of over 120° C. A hot melt adhesive having a softening point within this range is desirable in the field of building materials which are exposed to high temperatures for long periods of time because it affords high heat resistance. The softening points mentioned in this Specification are measured using the ring and ball method (Japan Adhesive Industry Association standard).

The hot melt adhesive of the present invention can be made in a variety of shapes, at room temperature it is typically in a block shape or film (sheet) shape. When it is in a block shape, it is obtained simply by cooling in hardening the product obtained according to the aforementioned manufacturing method. When it is in a film (sheet) shape, the product obtained according to the manufacturing method described above is formed into a sheet. Such forming methods which use drum rollers, T-die biaxial extruders, among others can be mentioned.

The hot melt adhesive of this invention has a wide variety of applications in building materials, paper manufacturing, bookbinding, and in disposable goods, but it finds particularly effective applications in the building materials industry where durability at high temperatures is required because of its low viscosity, and its superior adhesive strength and heat resistance.

Laminates structures obtained by using the hot melt adhesive of the present invention consists of adherents such as a variety of base materials and synthetic resin sheeting or synthetic resin films, or the like which are bonded together using the hot melt adhesive of this invention. The synthetic resins serving as raw materials for the sheeting and film adherents are preferably polyolefins, polyethylene terephthalates, polyurethanes, or the like, but preferentially polyolefins. Such polyolefins as polyethylene, polypropylene, ethylene/propylene copolymer, polybutene can be mentioned, but polyethylene is particularly preferential.

Base materials may be, for example, synthetic fibers (for example polyolefin, polyester, nylon, or acrylate), natural fibers (silk, cotton, flax, wool, or the like), inorganic fibers (glass fibers, mineral fibers, or the like), or nonwoven fabric, or knits thereof, as well as rubber, paper, metals, wood, glass, concrete mortar, or the like. Among these base materials, nonwoven fabrics are particularly preferable. Typical nonwoven fabrics may be used without impediment, but ideally they should have a weight per unit of area of 30-60 g/m2 and a thickness of 0.10-1.40 mm.

There is no limitation on the means of manufacturing the laminations of this invention as long as the laminated structure of the invention can be obtained, and typical well-known application (or coating) methods for hot melt adhesives may be used. These coating methods can be broadly classified as contact coating and non-contact coating. “Contact coating” refers to coating methods in which an extruding machine is brought into contact with such adherents as the base material, synthetic resin sheeting (film), and the like when applying the hot melt adhesive, while “non-contact coating” refers to methods for applying hot melt adhesives in which the extruding machine is not brought into contact with the base material, synthetic resin sheeting (film). For “contact coating,” such methods can be mentioned as slot coater application and rolled coater application, and the like, while for “noncontact coating,” such methods can be mentioned as spiral coating in which coating can be laid down in a spiral shape, omega coating and control seam coating in which coating is done in a sinuous pattern, slot spray coating and curtain spray coating in which planar coating can be performed, and dot coating in which the coating is applied in spot form, among others.

The laminated base material and synthetic resin sheeting, or the like, of the laminated structure of the present invention does not delaminate because it is obtained by bonding together base material and synthetic resin sheeting and other such adherents by using the above-described hot melt adhesive which has a high softening point and height heat resistance so that therefore the lamination of this invention can be used at high temperatures. Thus, there is very little likelihood that the base material and its adherents of the lamination of this invention would delaminate even when exposed for long periods of time outside in mid-summer, and a high degree of adhesion stability is thereby obtained. Therefore, the lamination of this invention is extremely effective in exterior structures and in protecting the surfaces of automobiles and other transport equipment as well as exterior equipment and the like.

The invention provides a hot melt adhesive comprising (A) a non-crystalline or amorphous alpha olefin, (B) a crystalline poly-alpha olefin obtained by polymerization of alpha olefin with metallocene, and (C) hydrogenated thermoplastic block copolymer which are copolymers with vinyl aromatic hydrocarbons and conjugated diene compounds. In one embodiment, the (C) hydrogenated thermoplastic block copolymer of the hot melt adhesive is a hydrogenated composition of styrene-isoprene-styrene block copolymer (SEAS). In another embodiment, the (A) amorphous poly-alpha olefin, (B) crystalline poly-alpha olefin, and (C) hydrogenated thermoplastic block copolymers (100 weight parts) are blended in a ratio 10-40 weight parts of (B). The invention also provides laminates obtained by using the hot melt adhesives of the invention.

The following is a description of an embodiment of this invention and comparative example. The invention is not limited to the following embodiment to the extent that it does not deviate from the spirit and scope of the present invention.

### EXAMPLES

The following is a description of components blended in a hot melt adhesive:

(A) Noncrystalline polyolefin
(A1) Noncrystalline ethylene polyolefin copolymer (from Huntsman Inc., trade name Rextac 2304)

(B) Crystalline poly-alpha olefin obtained by polymerizing alpha-olefin with metallocene catalyst.
(B1) Crystalline ethylene probably propylene copolymer (from Clariant Corp., trade name Licocene PP2602).

(C) Hydrogenated thermoplastic block copolymer
(C1) SEPS triblock copolymer (from Kraton Polymers LLC, trade name Septon 2063)
(C2) SEBS triblock copolymer (from Kraton Polymers LLC, trade name Kraton G1657)

Additives:

(D) Tackifiers
(D1) Solid-type tackifier (petroleum hydrocarbon hydrogenated derivative: Arkon M-100 (trade name) from Arakawa Chemical Co. Ltd.
(D2) Solid-type tackifier (phenolic modified terpene resin hydrogenated derivative: YS Polystar T115 (trade name) from Yasuhara Chemical Co. Ltd.
(D3) Liquid-type tackifier (petroleum hydrocarbon hydrogenated derivative: Maruca Clear-H (trade name) from Maruzen Petrochemicals Ltd.
(D4) Solid-type tackifier (phenolic modified terpene resin hydrogenated derivative: YS Polystar T115 (trade name) from Yasuhara Chemical Co. Ltd.

(E) Antioxidants
(E1) Hindered phenolic antioxidants (Tominox TT (trade name) from API Corporation)

(F′) Modified polypropylene
(F′) Modified polypropylene (Umex 1010 (trade name) from Sanyo Chemical Industries, Co. Ltd.)

The ingredients shown in Tables 1 and 2 were melted-blended at 150° C. for 3 hours using a general-purpose mixer to obtain the hot melt adhesive of Embodiments 1-5, as well as comparative examples 1-6 and evaluated for viscosity, softening point, adhesive strength, and adhesion stability.

To evaluate adhesive strength, hot melt adhesive was spread on polyethylene terephthalate film and polyethylene sheet. Evaluations of adhesion stability were performed by bonding together nonwoven fabric and polyethylene sheet, pressing these together at a predetermined temperature to produce a lamination for evaluative purposes. The following is a summary of analysis results.

Viscosity (mPa·S, Penetration into Nonwoven Fabric)

Hot melt adhesive is melted at 160° C. and viscosity was measured with a Brookfield viscometer using a #27 rotor. Analysis results were as follows:

\textcircled{⊙} Melt viscosity of less than 3000 mPa·s at 160° C.

◯ Melt viscosity of 3000 mPa·s to 5000 mPa·s at 160° C.

x Melt viscosity of over 5000 at mPa·s at 160° C.

### Softening Point (° C., Heat Resistance)

Softening point measured using the ring and ball method (Japan Adhesive Industry Association standard per standard JAI-7-1999).

\textcircled{⊙} Softening point of over 120° C.

◯ Softening point between 100° C. and 120° C.

x Softening point under 100° C.

### Adhesive Strength

### (Preparation of Samples)

Hot melt adhesive was coated at a thickness of 15 μm on PET (polyethylene terephthalate) film. Coating was performed manually with a hot roller. After applying the coating, the PET (polyethylene terephthalate) film and PE film were aligned with the hot melt adhesive disposed therebetween and pressed at a pressure of 0.3 MPa/cm2 to prepare a sample for analysis. Pressing was performed at a temperature of 116° C.

### (Test Method)

Samples prepared by pressing of 120° C. were cured for these 30 minutes at 20° C., 65% Rh. Subsequently, a Tensilon tester (from JT Toshi Co. Ltd.) was used to measure adhesive strength with T-shaped peeling. The measurement environment with the Tensilon was 20° C., 65% Rh, and a peeling speed of 300 mm/min.

\textcircled{⊙} Average peeling strength of PE and PET of over 1000 (g/25 mm)

◯ Average peeling strength of PE and PET of 700-1000 (g/25 mm)

x Average peeling strength of PE and PET of under 700 (g/25 mm)

### Evaluation of Adhesion Stability

### (Preparation of Samples)

PET (polyethylene terephthalate) film which had been prepared for release was coated with hot melt adhesive with a thickness of 15 μm. Coating was performed manually with a hot roller. The PET film coated with adhesive and a nonwoven fabric were aligned and the hot melt adhesive on the PET film was transferred to the non-woven fabric. The nonwoven fabric was pressed with PE (polyethylene) with the hot melt adhesive disposed therebetween at a pressure 0.3 MPa·cm2 to prepare samples for evaluation purposes. Pressing was performed at 116° C. and 120° C.

### (Test Method)

Two 2 types of samples, one in which pressing was done at 116° of PE sheet and nonwoven fabric with hot melt adhesive disposed therebetween, and another which was prepared at 120°, were left standing at an ambient temperature of 90° C. for 24 hours. After they had been left standing, the condition of the samples was observed. Moreover, samples which had been prepared at the lower temperature (116° C.) but in which the PE and nonwoven fabric had not been pressed were also observed under the same conditions.
\textcircled{⊙} Good adhesion between PE and nonwoven fabric, even when pressed at 116° C. (Good adhesion obtained in both the sample pressed at 120° C. and the one pressed at 116° C.)
◯ Good adhesion between the PE and the nonwoven fabric only in the sample pressed at above 120° C. (Sample prepared by pressing it 120° C. had good adhesion, but the PE field from the nonwoven fabric in the sample obtained by pressing it 116° C.)
x PE peeled from the nonwoven fabric even when pressed at above 120° C. (PE peeled from the nonwoven fabric in both the sample pressed at 120° C. and the one pressed at 116° C.)

TABLE 1

| | | | | Embodiment 1 | Embodiment 2 | Embodiment 3 | Embodiment 4 | Embodiment 5 |
|---|---|---|---|---|---|---|---|---|
| (A) | (A-1) | Rextac 2304 | | 60 | 60 | 60 | 60 | 70 |
| (B) | (B-1) | Licocene PP2602 | | 20 | 20 | 30 | 20 | 10 |
| (C) | (C-1) | Septon 2063 | | 20 | 20 | 10 | | 20 |
| | (C-2) | Kraton G1657 | | | | | 20 | |
| (D) | (D-1) | Arkon M-100 | | 86 | | 86 | 86 | 86 |
| | (D-2) | YS Polystar T115 | | | 86 | | | |
| | (D-3) | Maruca Clear H | | 14 | 14 | 14 | 14 | 14 |
| (E) | (E-1) | Tominox TT | | 0.6 | 0.6 | 0.6 | 0.6 | 0.6 |
| | | | | 200.6 | 200.6 | 200.6 | 200.6 | 200.6 |
| | | Target Properties | | | | | | |
| | | Viscosity (mPA · s) | 160° C. | 2,095 | 2,445 | 1,680 | 3,655 | 2,120 |
| | | | | [symbol] | [symbol] | [symbol] | ◯ | [symbol] |
| | | Softening point | | 122 | 125 | 124 | 127 | 127 |
| | | (° C.) | | [symbol] | [symbol] | [symbol] | [symbol] | [symbol] |
| | | Adhesive strength | Bond between | 1,420 | 1,054 | 1,286 | 1,327 | 1,050 |
| | | 20° C. (g/s 5 mm) | PET and PE | | | | | |
| | | | | [symbol] | [symbol] | [symbol] | [symbol] | [symbol] |
| | | Adhesion test | Bond between | ◯ | [symbol] | ◯ | ◯ | ◯ |
| | | 90° C. × 1 day | nonwoven | | | | | |
| | | | fabric and PE | | | | | |

TABLE 2

| | | | Comp. Ex. 1 | Comp. Ex. 2 | Comp. Ex. 3 | Comp. Ex. 4 | Comp. Ex. 5 | Comp. Ex. 6 |
|---|---|---|---|---|---|---|---|---|
| (A) | (A-1) | Rextac 2304 | | 100 | | 80 | | 80 |
| (B) | (B-1) | Licocene PP2602 | | | 100 | | 60 | |
| (C) | (C-1) | Septon 2063 | 100 | | | 20 | 40 | 20 |
| (D) | (D-1) | Arkon M100 | 86 | 86 | 86 | 86 | 86 | |
| | (D-2) | YS Polystar T115 | | | | | | 40 |
| | (D-3) | Maruca Clear H | 14 | 14 | 14 | 14 | 14 | |
| | (D-4) | YS Polystar PX115 | | | | | | 40 |
| (E) | (E-1) | Tominox TT | 0.6 | 0.6 | 0.6 | 0.6 | 0.6 | 0.6 |
| (F) | (F-1) | Umex 1010 | | | | | | 10 |

| | | 200.6 | 200.6 | 200.6 | 200.6 | 200.6 | 200.6 |
|---|---|---|---|---|---|---|---|
| Target Properties | | | | | | | |
| Viscosity (mPA · s) | 160° C. | 245,000 | 418 | 1,965 | 2,115 | 13,350 | — |
| | | x | [symbol] | [symbol] | [symbol] | x | x |
| Softening point | | 134 | 128 | 88 | 128 | 110 | 127 |
| (° C.) | | | | | | | |
| | | [symbol] | [symbol] | x | [symbol] | ∘ | [symbol] |
| Adhesive strength | Bond between | — | 237 | 561 | 263 | — | — |
| 20° C. (g/s 5 mm) | PET and PE | | | | | | |
| | | — | x | x | x | — | — |
| Adhesion test | Bond between | — | x | ∘ | ∘ | x | x |
| 90° C. × 1 day | nonwoven | | | | | | |
| | fabric and PE | | | | | | |

As shown in Table 1, the adhesives of embodiments 1-5 have low viscosity so they penetrate well into nonwoven fabric and have superior heat resistance because their softening points are high. Samples pressed at 120° C., Embodiments 1-5, had superior adhesive strength at 20° C., and did not peel even when left standing for 24 hours at 90° C. Therefore, the hot melt adhesives of the present invention (Embodiments 1-5) are suitable for use in the building materials field where there is a great deal of exposure to high temperatures.

As shown in Table 2, the adhesives of Comparative Examples 1-6 are inferior to Embodiments 1-5 in terms of viscosity, heat resistance, adhesive strength, and adhesion stability. In the building materials field where there is significant exposure to high temperatures, the hot melt adhesives of Embodiments 1-5 are more suitable for use than the hot melt adhesives of the Comparative Examples 1-6.

1. A hot melt adhesive comprising
(A) a non-crystalline poly-α-olefin,
(B) a crystalline poly-α-olefin obtained by polymerizing an α-olefin in the presence of a metallocene catalyst, and
(C) a hydrogenated thermoplastic block copolymer which is a copolymer of a vinyl-based aromatic hydrocarbon and a conjugated diene compound.

2. The hot melt adhesive of claim 1, wherein the (C) hydrogenated thermoplastic block copolymer is a hydrogenated styrene-isoprene-styrene block copolymer.

3. The hot melt adhesive of claim 1 wherein the (B) crystalline poly-α-olefin is present in a ratio of 10-40 weight parts of 100 weight parts of the combined (A), (B) and (C).

4. An article comprising the hot melt adhesive of claim 2.

5. The article of claim 4 which is a laminated article.

6. The article of claim 5 comprising a nonwoven sheet bonded to a plastic film.

7. The article of claim 5 which is a vapor permeable laminate.

8. The article of claim 5 which is waterproof laminate.
